(19) United States
(12) Patent Application Publication
(10) Pub. No.: US 2020/0362210 A1
(43) Pub. Date: Nov. 19, 2020

(54) SOLID ADHESIVE

(71) Applicants: TOMBOW PENCIL CO., LTD., Tokyo (JP); UNIVERSITY OF HYOGO, Hyogo (JP)

(72) Inventors: Motoya SAKATO, Tokyo (JP); Akihiro SAKAMOTO, Tokyo (JP); Kazuhisa AOKI, Tokyo (JP); Hajime KISHI, Hyogo (JP)

(21) Appl. No.: 16/876,742

(22) Filed: May 18, 2020

(30) Foreign Application Priority Data
May 17, 2019 (JP) 019-93554

(51) Int. Cl. C09J 139/06; C09J 103/02; C09J 9/00; B65D 83/00

(52) U.S. Cl. CPC C09J 139/06; C09J 103/02; C09J 2403/00; B65D 83/0011; C09J 9/005

(57) ABSTRACT

A solid adhesive is described that has an excellent finish, a light coating feeling, and is also capable of adhering to paper, wood, cloth, and the like. The solid adhesive contains water, an organic solvent, a gelation agent such as a dibenzalide of pentavalent to hexavalent sugar alcohol, and a polyvinyl formal resin. In some examples, the solid adhesive further includes a polyvinyl butyral resin and/or an adhesive resin such as a polyvinyl pyrrolidone resin. A feed type solid adhesive may be provided, including a feeding container that is filled with the solid adhesive described above.

### FIELD

The present disclosure relates to solid adhesives.

### INTRODUCTION

Recently, DIY (i.e., do-it-yourself, or making a workpiece by oneself) has been a popular pursuit, and an adhesive that is capable of adhering to not only paper but also wood or cloth has become desirable. However, such general adhesives are normally liquid, and thus, have problems in use, such as dripping or easily contaminating hands.

For this reason, a solid adhesive has been proposed (for example, refer to Patent Document 1). In one example, a water-soluble resin polymer (a mixture of polyvinyl pyrrolidone and polyurethane) is used as a main adhesive component, and a soap (an alkali metal salt or an ammonium salt of an aliphatic carboxylic acid) is used in a gelation agent. However, with respect to the soap gel-based solid adhesive using polyvinyl pyrrolidone and polyurethane, the surface of the adhesive is in a dried state, thereby making it difficult to attach the adhesive to an adherend, or the adhesive is ragged, thereby making it difficult to spread the adhesive on the surface of the adherend, and a solid fragment may remain on the surface of the adherend in some cases.

In another example, a soap gel-based solid adhesive has been proposed in which attachment properties of the adhesive component with respect to the adherend are improved by using terminal-silylated urethane (see Patent Document 2), but a large resistance may be experienced during coating. In addition, in such a soap gel-based solid adhesive, the soap itself is a white opaque soap, and thus, in a case where the adhesive is applied to a dark adherend, the whiteness of the adhesive is noticeable, and in some cases the adherend is seen as being contaminated.

Further, the pH of the soap gel-based solid adhesive is alkaline (pH 9 to pH 13). In general, such alkalinity is not a problem since the adhesive is neutralized by carbon dioxide or the like in the air after coating, but in the adhesion of wood, there is a case where the surface of the adherend to which the adhesive is attached is discolored (so-called alkali contamination).

On the other hand, solid adhesives using a benzylidene derivative of sorbitol in the gelation agent are basically transparent due to the constituent, and have pH in a neutral region. Thus, even in a case where the adhesive is attached to the adherend, the adherend is not seen as being contaminated or the adherend (wood) is not discolored, and the finish of the coated surface is excellent. However, there is a drawback in that the coating feels hard and heavy.

A solid adhesive has been also proposed in which spherical fine particles are blended, excellent coating performance and an excellent adhesive force can be ensured with a light pressing force, and strength and coating performance do not decrease (see Patent Document 3). A benzoguanamine.formaldehyde condensate or glass beads having an average particle diameter of 0.3 μm to 30 μm are used as the spherical fine particles, polyvinyl pyrrolidone or the like is used as an adhesive component, and wax that is a solid at a normal temperature and has small solubility with respect to a solvent is used together, and thus, a decrease in an effect due to long storage or use is prevented. However, a comparatively large amount of gelation agent is used in order to retain shapability. Thus, the coating feeling is hard, an adhesive edge is easily ragged, and not only a decrease in the transparency of the adhesive but also an insufficient adhesive force with respect to the adherend (paper) is caused by the wax or the spherical fine particles.

### CITATIONS

Patent Document 1: Japanese Patent No. 4,870,260

Patent Document 2: Japanese Patent No. 3,350,532

Patent Document 3: JP-A-2003-049149

### SUMMARY

The adhesives of the present disclosure have been made in consideration of the problems of the related art. Adhesives described herein may provide a solid adhesive that has an excellent finish with respect to a coated surface of an adherend, without causing the adherend to be seen as being contaminated or causing alkali contamination. Adhesives of the present disclosure may have a light coating feeling, and are also capable of adhering to not only paper but also wood, cloth, or the like. A feed type solid adhesive may include a feeding container that is filled with a solid adhesive of the present disclosure, e.g., forming a glue stick.

As a result of intensive studies of the present inventor for attaining one or more of the advantages described above, adhesives of the present disclosure utilize a polyvinyl formal resin.
1) Embodiments of the present disclosure include a solid adhesive comprising water; an organic solvent; a gelation agent; and a polyvinyl formal resin.
2) The solid adhesive according to 1) described above, in which a content of the polyvinyl formal resin is 0.1 mass % to 5.0 mass %, with respect to a total amount of the solid adhesive.
3) The solid adhesive according to 1) or 2) described above, further containing: at least one polyvinyl acetal resin selected from polyvinyl acetal resins other than the polyvinyl formal resin.
4) The solid adhesive according to 3) described above, in which a ratio (a mass ratio) of the polyvinyl formal resin to the polyvinyl acetal resin is 1/99 to 50/50.
5) The solid adhesive according to 3) or 4) described above, in which the polyvinyl acetal resin is a polyvinyl butyral resin.
6) The solid adhesive according to any one of 1) to 5) described above, further containing: at least one adhesive component selected from the group consisting of a synthetic macromolecule and a natural macromolecule other than the above.
7) The solid adhesive according to 6) described above, in which the adhesive component is a polyvinyl pyrrolidone resin.
8) The solid adhesive according to any one of 1) to 7) described above, in which the gelation agent is a dibenzalide of pentavalent to hexavalent sugar alcohol.
9) In some embodiments, a feed type solid adhesive includes:
a feeding container that is filled with the solid adhesive according to any one of 1) to 8).
10) The feed type solid adhesive according to 9) described above, in which a hardness of the solid adhesive is in a range of 1×10⁻⁵ N/cm² to 15×10⁻⁵ N/cm².

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is an isometric view of an illustrative feed type solid adhesive in accordance with aspects of the present disclosure.

FIG. 2 is a sectional view of the illustrative feed type solid adhesive of FIG. 1.

FIG. 3A is a first portion of a table depicting experimental results with respect to several blended compositions.

FIG. 3B is a second portion of the table of FIG. 3A.

### DETAILED DESCRIPTION

Various aspects and examples of an improved solid adhesive, as well as related devices and methods, are described below and illustrated in the associated drawings. Unless otherwise specified, a solid adhesive in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

The following describes selected aspects of illustrative solid adhesives, as well as related systems and/or methods. The examples below are intended for illustration and should not be interpreted as limiting the scope of the present disclosure.

A solid adhesive according to the present disclosure contains water, an organic solvent, a gelation agent, and a polyvinyl formal resin.

In the solid adhesive disclosed herein, water and the organic solvent are contained as a solvent. A ratio of water and the organic solvent is not particularly limited, and can be suitably set in consideration of a balance in adhesive properties, preservation stability, a gelation state, and the like of the solid adhesive. However, the ratio of the organic solvent is preferably 50 parts by mass to 200 parts by mass, and is more preferably 100 parts by mass to 150 parts by mass, with respect to 100 parts by mass of water. By using water and the organic solvent with an excellent balance, compatibility between the gelation agent and the resin is also excellent, the transparency of the solid adhesive is ensured, and the adhesive properties are improved. In addition, this balance facilitates the suppression of wrinkles on a paper surface coated with the solid adhesive.

A total amount of water and the organic solvent (the solvent) is preferably 50 mass % to 90 mass %, is more preferably 50 mass % to 85 mass %, and is particularly preferably 55 mass % to 80 mass %, with respect to a total amount of the solid adhesive. In a case where the amount of solvent is excessively small, the resin is not capable of being dissolved, and in a case where the amount of solvent is excessively large, it is difficult to prepare a solid adhesive having a suitable hardness.

The organic solvent in the disclosed solid adhesive is not particularly limited. Examples thereof include lower alcohols such as ethyl alcohol and isopropyl alcohol; polyhydric alcohols such as ethylene glycol, glycerin, and 3-methyl-3-methoxy-1-butanol; aliphatic hydrocarbons such as hexane and heptane; alicyclic hydrocarbons such as cyclohexane; glycol ethers such as ethylene glycol monomethyl ether, ethylene glycol monoethyl ether, ethylene glycol monopropyl ether, ethylene glycol monobutyl ether, ethylene glycol monophenyl ether, propylene glycol monomethyl ether, propylene glycol monoethyl ether, diethylene glycol monomethyl ether, diethylene glycol monoethyl ether, diethylene glycol monoisopropyl ether, and diethylene glycol monobutyl ether; and the like, and such organic solvent can be independently used or two or more kinds thereof can be used by being mixed.

As described above, the solid adhesive of the present disclosure contains water and the organic solvent, and thus, it is preferable that the organic solvent has high solubility with respect to water. It is more preferable that the organic solvent is freely mixed with water. Further, so as to prevent the solvent from being evaporated from the solid adhesive that is gelated, a decrease in a coating amount due to the drying of the solid adhesive, or the degradation of coating feeling, it is particularly preferable that a boiling point of the organic solvent at a normal pressure is 100° C. or higher.

From such a viewpoint, polyhydric alcohols and glycol ethers are preferable as the organic solvent, and among them, 3-methyl-3-methoxy-1-butanol, and propylene glycol monomethyl ether are more preferable, and propylene glycol monomethyl ether is particularly preferable.

The gelation agent is utilized to gelate a mixture of the resin such as polyvinyl formal, water, and the organic solvent. A gelation agent suitably selected from known gelation agents may be used as the gelation agent, and specific examples thereof include a dibenzalide of pentavalent to hexavalent sugar alcohol, a fatty acid derivative such as an aliphatic carboxylate and fatty acid amide, a cellulose derivative such as hydroxy ethyl cellulose and hydroxy propyl cellulose, an inorganic compound such as organic bentonite and silica, natural macromolecule polysaccharide containing carrageenan or agar, glucose, a glucuronic acid, and rhamnose as constituent sugar, and the like. Such gelation agents can be independently used, or two or more kinds thereof can be used together. Among them, a dibenzalide of pentavalent to hexavalent sugar alcohol is preferable from the viewpoint of having excellent shapability, generally neutral pH, and enabling a transparent gel to be formed.

Such a dibenzalide of sugar alcohol, for example, is a condensate of pentavalent to hexavalent sugar alcohol such as mannitol, rhamnitol, xylitol, and sorbitol, and benzaldehyde or a nucleus substitute thereof, and can be independently used or can be used as a mixture of the sugar alcohol and a monobenzalide or a tribenzalide. In particular, a dibenzalide of xylitol, sorbitol, or a mixture thereof exhibits excellent shapability.

A dibenzalide of sorbitol can be obtained as a commercially available product, and examples thereof include “Millad 3988” (manufactured by Milliken & Company), “GEL ALL D” (manufactured by New Japan Chemical co., ltd.), “GEL ALL MD” (manufactured by New Japan Chemical co., ltd.), and the like.

A preferred range of the amount of gelation agent used differs depending on the kind and the amount of organic solvent and the kind and the amount of resin, but is preferably 0.5 mass % to 10 mass %, is more preferably 1 mass % to 8 mass %, and is particularly preferably 1 mass % to 5 mass %, with respect to the total amount of the solid adhesive. In a case where the amount of gelation agent used is small, there is a concern that the gelation of the solid adhesive is insufficient, the shapability is not capable of being obtained, and/or the solid adhesive collapses at the time of coating. On the other hand, in a case where the use amount is large, the solid adhesive becomes hard, and it is difficult to obtain a sufficient coating amount for adhesion at the time of coating.

The resin is mainly utilized to impart the adhesive properties to the solid adhesive, and it is possible to attain light coating feeling by using the polyvinyl formal resin. The polyvinyl formal resin represented by General Formula (1) described below is a resin that is obtained by the formalization of polyvinyl alcohol, and is insoluble in water at normal temperature (20±15° C.). A weight average molecular weight of the polyvinyl formal resin is preferably 10,000 to 250,000, is more preferably 20,000 to 200,000, and is particularly preferably 40,000 to 150,000. In a case where the molecular weight is excessively small, a coating resistance reduction effect (light coating feeling) is impaired, whereas in a case where the molecular weight is excessively large, pressure-sensitive adhesive properties with respect to an adherend (a pressure-sensitive adhesive force before an adhesive component is solidified) tend to decrease.

In addition, it is preferable that in the polyvinyl formal resin, the content of a hydroxyl group is 10 mass % or less, and the content of an acetic acid group is 5 mass % to 15 mass %.

A single kind of the polyvinyl formal resins can be independently used, or two or more kinds thereof having different molecular weights or different contents of the hydroxyl group can be used by being mixed together.

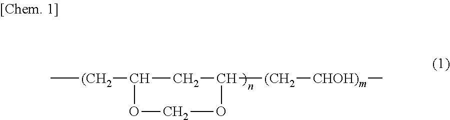

A preferred range of an amount of the polyvinyl formal resin used differs in accordance with the kind and the amount of organic solvent and the kind of resin, but is preferably 0.1 mass % to 5.0 mass %, is more preferably 0.25 mass % to 3.5 mass %, and is particularly preferably 0.5 mass % to 2.5 mass %, with respect to the total amount of the solid adhesive. In a case where the use amount is 0.1 mass % or more, it is possible to obtain the coating resistance reduction effect, and in a case where the use amount is 5.0 mass % or less, the compatibility of the solvent and the resin is not degraded.

The polyvinyl formal resin can be obtained as a commercially available product, and examples thereof include “VINYLEC” (manufactured by JNC Corporation), “Vinylec-F” (manufactured by SIVA CHEMICAL INDUSTRIES), and the like.

In the present disclosure, it is preferable that the polyvinyl formal resin and at least one kind of polyvinyl acetal resin selected from polyvinyl acetal resins other than the polyvinyl formal resin are used together as the resin.

The polyvinyl acetal resin is a general term for resins obtained by acetalizing polyvinyl alcohol with aldehyde. Examples of the polyvinyl acetal resin include a polymer having a vinyl acetal unit represented by General Formula (2) described below as a main unit and a vinyl alcohol unit or the like as a repeating unit, and include a polyvinyl acetoacetal resin (R₁ in General Formula (2) is a methyl group), a polyvinyl propyral resin (R₁ in General Formula (2) is an ethyl group), a polyvinyl butyral resin (R₁ in General Formula (2) is a propyl group), and the like.

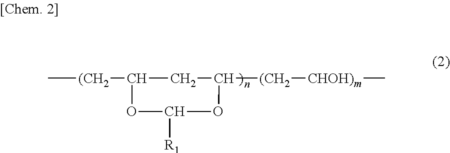

(R₁ represents an alkyl group.)

Among such resins, the polyvinyl butyral resin is preferable from the viewpoint of improving availability, the compatibility with respect to the solvent or the resin, and the shapability. The polyvinyl butyral resin is a copolymer of vinyl butyral, vinyl acetate, and vinyl alcohol, various kinds of polyvinyl butyral resins having different degrees of polymerization or different amounts of hydroxyl group can be used, and a single kind of the polyvinyl butyral resin can be independently used or two or more kinds thereof can be used together.

A preferred range of an amount of the polyvinyl butyral resin used differs in accordance with the kind and the amount of organic solvent and the kind of resin, but is preferably 1 mass % to 20 mass %, is more preferably 5 mass % to 15 mass %, and is particularly preferably 8 mass % to 12 mass %, with respect to the total amount of the solid adhesive.

The polyvinyl butyral resin can be obtained as a commercially available product, and specific examples thereof include S-LEC BL-1 (a calculated molecular weight of 1.9×10⁴ and 36 mol % of a hydroxyl group), S-LEC BL-2 (a calculated molecular weight of 2.7×10⁴ and 36 mol % of a hydroxyl group), S-LEC BM-1 (a calculated molecular weight of 4.0×10⁴ and 34 mol % of a hydroxyl group), S-LEC BM-2 (a calculated molecular weight of 5.2×10⁴ and 31 mol % of a hydroxyl group), S-LEC BM-S (a calculated molecular weight of 5.3×10⁴ and 22 mol % of a hydroxyl group), S-LEC BM-SZ (a calculated molecular weight of 5.3×10⁴ and 22 mol % of a hydroxyl group), S-LEC BH-3 (a calculated molecular weight of 11.0×10⁴ and 34 mol % of a hydroxyl group), S-LEC BH-6 (a calculated molecular weight of 9.2×10⁴ and 30 mol % of a hydroxyl group), S-LEC KX-1 (a calculated molecular weight of 17.5×10⁴ and 80 mol % of a hydroxyl group), S-LEC KX-5 (a calculated molecular weight of 10×10⁴ and 80 mol % of a hydroxyl group), S-LEC KW-1 (a calculated molecular weight of 3.0×10⁴ and 80 mol % of a hydroxyl group), S-LEC KW-3 (a calculated molecular weight of 3.0×10⁴ and 80 mol % of a hydroxyl group), S-LEC KW-10 (a calculated molecular weight of 3.0×10⁴ and 80 mol % of a hydroxyl group) (all are manufactured by SEKISUI CHEMICAL CO., LTD.), and the like. The calculated molecular weight indicates a weight average molecular weight that is obtained from a weight average molecular weight of polyvinyl alcohol that is a raw material.

A weight average molecular weight of the polyvinyl butyral resin depends on a molecular weight of polyvinyl alcohol that is a raw material. The weight average molecular weight of the polyvinyl butyral resin that is used in the solid adhesives described herein is preferably 5,000 to 500,000, is more preferably 10,000 to 300,000, and is particularly preferably 20,000 to 100,000. It is preferable that the polyvinyl butyral resin is a polyvinyl butyral resin that is soluble in a mixed solution of Water/Organic Solvent, and it is most preferable that the polyvinyl butyral resin is a polyvinyl butyral resin in which the viscosity of 20 mass % of an aqueous solution at 25° C. is 100 mPa·s to 5000 mPa·s.

In a case where the polyvinyl formal resin and the polyvinyl acetal resin are used together, a ratio (a mass ratio) of the polyvinyl formal resin to the polyvinyl acetal resin is preferably in a range of 1/99 to 50/50, is more preferably in a range of 3/97 to 40/60, and is particularly preferably in a range of 5/95 to 25/75, in terms of a solid content. In a case where the ratio of the polyvinyl formal resin is excessively high, the adhesive properties with respect to the adherend tend to decrease, and on the contrary, in a case where the ratio of the polyvinyl formal resin is excessively low, the coating resistance reduction effect decreases.

In the solid adhesive of the present disclosure, an adhesive force is improved while the effect of light coating feeling is obtained, by using the polyvinyl formal resin and the polyvinyl butyral resin together, compared to a case where the polyvinyl formal resin is independently used. For this reason, the solid adhesive is more suitable for an adherend such as not only paper but also wood or cloth.

To improve the adhesive properties of the solid adhesive, known adhesive resins may be further included in the solid adhesive. A synthetic macromolecule or a natural macromolecule that has film formability and is soluble or dispersible in water can be used as the adhesive resin.

Specific examples of the adhesive resin include a synthetic macromolecule such as polyvinyl alcohol (a partially saponified product or a completely saponified product), polyvinyl acetate, a vinyl acetate copolymer (a comonomer; ethylene, propylene, a crotonic acid, an acrylic acid, a methacrylic acid, a maleic acid, acrylamide, and the like) and a saponified product thereof, a polyacrylate, polyacrylamide, polyhydroxy ethyl methacrylate, polyethylene glycol, polypropylene glycol, polyvinyl pyrrolidone, polyethylene imine, polyvinyl methyl ether, and an acryl resin emulsion (a polymer; a homopolymer or a copolymer of acrylic acid ester or methacrylic acid ester, specifically, a copolymer that mainly contains ethyl acrylate, butyl acrylate, and 2-ethyl hexyl acrylate and is copolymerized with methacrylic acid ester, styrene, acrylonitrile, vinyl acetate, and the like), a natural macromolecule such as methyl cellulose, ethyl cellulose, hydroxy propyl cellulose, carboxy methyl cellulose, sodium alginate, locust bean gum, tragacanth gum, gum arabic, gelatin, dextrin, cornstarch, ethoxylated and propoxylated starch, carboxy methyl starch, and other starch derivatives thereof, and enzyme-modified starch, and the like. Such adhesive resins may be independently used or two or more kinds thereof may be used together.

A preferred range of an amount of the adhesive resin used differs in accordance with the kind and the amount of organic solvent and the kind of resin, but is preferably 10 mass % to 50 mass %, is more preferably 15 mass % to 50 mass %, and is particularly preferably 18 mass % to 40 mass %, with respect to the total amount of the solid adhesive. In a case where the content of the adhesive resin is excessively large, it is difficult to homogeneously mix the adhesive resin into the organic solvent, whereas in a case where the content of the adhesive resin is excessively small, there is a concern that a desired adhesive force is not capable of being obtained or a sufficient hardness as the solid adhesive is not capable of being obtained.

Among the adhesive resins, polyvinyl pyrrolidone is preferable from the viewpoint of having high compatibility with respect to various solvents or resins and high pressure-sensitive adhesive properties. In addition, polyvinyl pyrrolidone is also excellent in film-forming performance in water and the organic solvent.

Polyvinyl pyrrolidone can be obtained as a commercially available product, and preferred specific examples thereof include PVP K-15, PVP K-30, PVP K-90, and PVP K-120 (all are manufactured by Ashland Japan, Co., Ltd.), PITZCOL K-30 and PITZCOL K-90 (all are manufactured by DKS Co. Ltd.), polyvinyl pyrrolidone K-30 and polyvinyl pyrrolidone K-90 (all are manufactured by Nippon Shokubai Co., Ltd.), and the like. Note that, a weight average molecular weight of polyvinyl pyrrolidone may be suitably selected from a range of 5,000 to 3,000,000, and a product may be in the shape of a powder, a granule, or a liquid.

A colorant or a pigment, a fragrance, an antifungal agent, an antiseptic agent, and/or the like can be added to the solid adhesive, in addition to water, the organic solvent, the adhesive component, and the gelation agent, within a range not impairing the effects described herein. Further, a plasticizer, a lubricant, a wetting agent, an extending agent, a moisturizing agent, a surfactant, an emulsifier, for example, triethylene glycol, tetraethylene glycol, sorbit, mannite, glucose, low-molecular weight polyethylene glycol, glycerin, sodium hyaluronate, and/or the like can be added as an auxiliary agent.

In the case of preparing the solid adhesive according to the present disclosure, the adhesive component, the gelation agent, and other components, and the residual amount of water and organic solvent are put in a mixing machine that is adjusted to 40° C. to 120° C., and are mixed at a stirring rate of 50 rpm to 300 rpm for approximately 10 minutes to 120 minutes to obtain a homogeneous mixture, and thus, a material for injection molding is obtained.

The material injected into a mold is solidified while being cooled, and thus, the solid adhesive is obtained. A cooling method of the material may be slow cooling or rapid cooling.

The hardness of the solid adhesive injected into the mold can be set in accordance with the shape of a feeding container filled with the solid adhesive. The hardness of the solid adhesive is measured from the value of a resistance load when a load of 0 gf to 400 gf is applied to a needle having a tip end diameter of 1.5 mm, by a rheometer (e.g., Cardmeter-Max_ME-500, manufactured by ASKA CORPORATION).

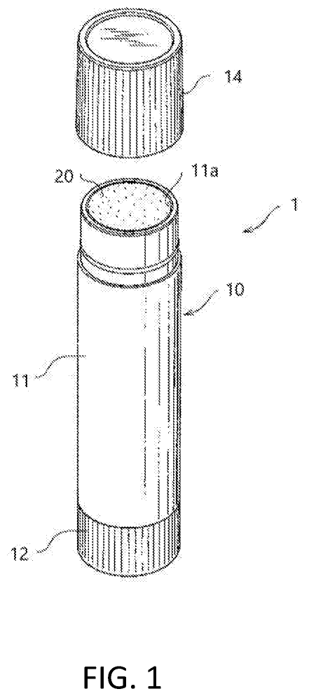

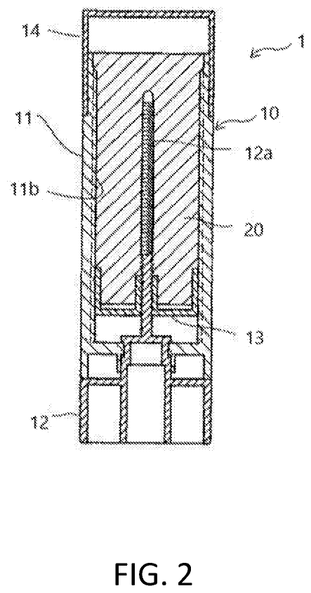

The feeding container is filled with the solid adhesive that is obtained by the method described above, and thus, a “feed type” solid adhesive is obtained. (See, for example, FIGS. 1 and 2). On a coating side, a forward end of the solid adhesive appears from an opening of the feeding container, and thus, a hardness or a softness may be selected for ensuring a preferred coating amount with respect to the adherend such as paper, wood, or cloth. On a slider side, a hardness may be selected for preventing a phenomenon in which a slider portion is torn, and thus, the solid adhesive is dropped out from the slider, and the solid adhesive is not capable of being contained in the feeding container. That is, in the feed type solid adhesive, a hardness satisfying both conditions is desirable.

In the solid adhesive of the present disclosure, the degree of hardness is preferably in a range of 1×10⁻⁵ N/cm² to 15×10⁻⁵ N/cm², is more preferably in a range of 3×10⁻⁵ N/cm² to 11×10⁻⁵ N/cm², and is particularly preferably in a range of 5×10⁻⁵ N/cm² to 7×10⁻⁵ N/cm², in an environment of 23° C. and 60% RH. By adjusting the hardness of the solid adhesive as described above, it is possible to obtain a solid adhesive that is less likely to be dropped out from the slider while ensuring a preferred coating amount.

The solid adhesive of the present disclosure can be used for the adhesion of paper, wood, cloth, or the like. Examples of such paper include high-quality paper, craft paper, photographic paper, envelope paper, drawing paper, coated paper, cardboard, and the like. Examples of such wood include a veneer such as a paulownia material, an Asada material, a cedar material, a birch material, and a Japanese cypress material, a laminated veneer lumber (a wooden board in which a plurality of veneers obtained by slimly slicing wood are stacked by aligning a fiber direction in the same direction, and are subjected to thermal-pressure adhesion through an adhesive), a plyboard (in which veneers are subjected to adhesion through an adhesive), a particle board (a wooden board in which a small piece obtained by cutting or crushing wood is mixed with an adhesive to be in the shape of a mat, and is subjected to thermal-pressure clamping), a fiber board (a wooden board in which a small piece obtained by steam-injecting and defibrating wood is mixed with an adhesive to be in the shape of a mat, and is subjected to thermal-pressure clamping; a medium density fiberboard (MDF), a hardboard (HB), an insulation board, and the like), OSB (in which a raw material in the shape of a thin cut piece is aligned and laminated, and is subjected to adhesion), a laminated lumber (in which sawn plates, small timbers, or the like are parallel to each other in a fiber direction, and are subjected to laminated-adhesion in a length direction, a width direction, and a thickness direction), a block board (in which a block-shaped small piece is subjected to laminated-adhesion into the shape of a plate), a wooden composite material (in which a surface-dressed lumber, a fiber mat, or the like is jointed onto one surface or both surfaces of a wooden board through an adhesive), and the like. Examples of such cloth include a woven fabric, a knitted fabric, a non-woven fabric, and the like, in which a cellulose-based fiber material (such as cotton and linen) and a synthetic fiber material (such as polyester and nylon) are each independently used or are used by being mixed.

With reference to the example depicted in FIGS. 1 and 2, an illustrative feed type solid adhesive 1 includes a solid adhesive 20 held in a tubular body 11 of a feeding container 10. Feed type solid adhesive 1 is an illustrative embodiment of the apparatus described above. Any suitable feeding container may be utilized.

In this example, a screw mechanism 12a internal to body 11 is actuated by a rotary block 12 (also referred to as a breech block) to urge solid adhesive 20 out of and/or into the tubular body through an opening 11a. Specifically, a slider 13 is coupled to a proximal end of the solid adhesive, and rides on the threaded rod of the screw mechanism, which is rotated by block 12.

Solid adhesive 20 and/or slider 13 ride on a guide ridge 11b, which runs along an interior wall of tubular body 11. Guide ridge 11b prevents rotation of slider 13 and solid adhesive 20 as screw mechanism 12a is actuated, resulting in an axial motion of the adhesive. A removable cap 14 is configured to be placed over opening 11a to protect the contents. Cap 14 may include threads for mating with an end of container 10, or may be attached using a friction fit.

### SPECIFIC EXAMPLES

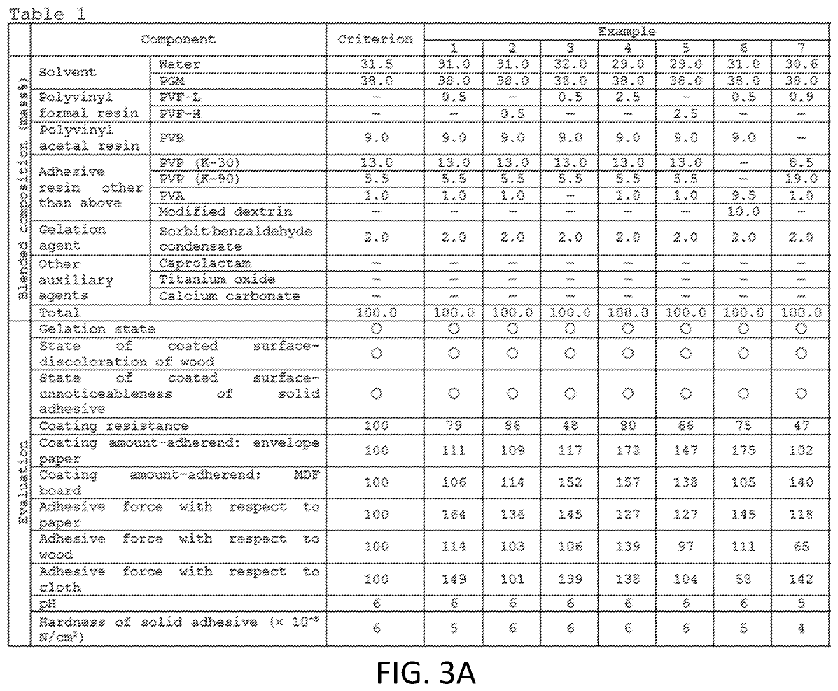

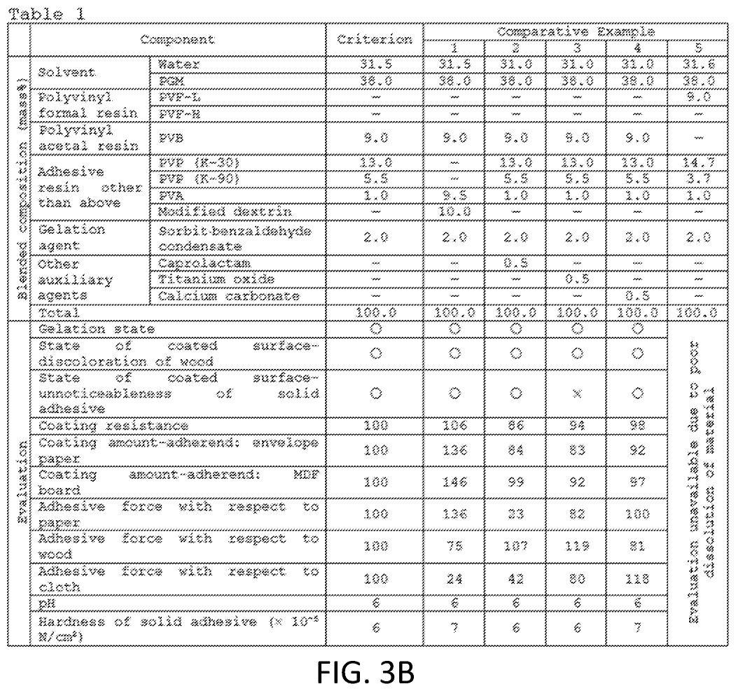

Hereinafter, aspects of the present disclosure will be described in more detail, by using examples and comparative examples, each of which is non-limiting. Reference is made to Table 1, which is depicted in FIGS. 3A and 3B of the associated drawings.

### Examples 1 to 7 and Comparative Examples 1 to 6

Each blend component was heated and stirred at a blending ratio shown in Table 1 in a mixing machine provided with a stirring machine until a sufficiently homogeneous material was obtained. Next, such a thermal material was injected into a cylindrical feeding container having an inner diameter of 16 mm (specifically, a feeding container “PiT HI-POWER S”, Product Number: PT-TP, manufactured by TOMBOW PENCIL CO., LTD.). After that, cooling was performed, and thus, a feed type solid adhesive was obtained.

Each component used in Table 1 is as follows.

PGM: Propylene Glycol Monomethyl Ether

PVF-L (Polyvinyl Formal); “VINYLEC K Type”, Molecular Weight: 4,400 to 54,000, Content of Hydroxyl Group of 5.75±0.75% (manufactured by JNC Corporation)

PVF-H (Polyvinyl Formal); “VINYLEC E Type”, Molecular Weight: 95,000 to 134,000, Content of Hydroxyl Group of 5.75±0.75% (manufactured by JNC Corporation)

PVB (Polyvinyl Butyral); “S-LEC KW”, Molecular Weight: 30,000 (manufactured by SEKISUI CHEMICAL CO., LTD.)

PVP-K30 (Polyvinyl Pyrrolidone); “PITZCOL K-30”, Molecular Weight: 45,000 (manufactured by DKS Co. Ltd.) PVP-K90 (Polyvinyl Pyrrolidone); “PITZCOL K-90”, Molecular Weight: 1,200,000 (manufactured by DKS Co. Ltd.)

PVA (Polyvinyl Alcohol); “PVA-217”, Degree of Polymerization: 1,700 (manufactured by KURARAY CO., LTD.)

Modified Dextrin (Hydroxypropylated Enzyme-Modified Dextrin): “PENON PKW” (manufactured by Nippon Starch Chemical Co., Ltd.)

Gelation Agent (Sorbit.Benzaldehyde Condensate: Dibenzylidene Sorbitol); “GEL ALL D” (manufactured by New Japan Chemical co., ltd.)

(1) Gelation State

A total amount of the obtained solid adhesive was fed from the feeding container, and then, whether or not the solid adhesive was capable of being returned to the end was visually observed, and evaluation was performed on the basis of the following criteria.
◯; Feeding and returning are capable of being performed normally.
x; Feeding and returning are not capable of being performed to the end.

(2) State of Coated Surface

(a) Discoloration of Wood

A paulownia material was coated with the solid adhesive, and was left to stand during a whole day and night, and then, the state of the coated surface was visually observed, and evaluation was performed on the basis of the following criteria.
◯; The paulownia material is not discolored.
x; The paulownia material is discolored.

(b) Unnoticeableness of Solid Adhesive

The paulownia material was coated with the solid adhesive and was dried, and the state of the coated surface was visually observed, and evaluation was performed on the basis of the following criteria.
◯; The solid adhesive is not noticeable.
x; The color (white) of the solid adhesive is noticeable.

(3) Coating resistance, a coating amount, and an adhesive force with respect to paper, wood, and cloth were evaluated by the following method, by setting an evaluation value of a reference composition as 100.
(a) Coating Resistance

Envelope paper (manufactured by LINTEC Corporation, a half-tone color, unit weight of 104.7 g/m²) placed on a horizontal base is installed in a push-pull gauge (DS2-500N, manufactured by IMADA SEISAKUSHO CO., LTD) such that a surface coated with the solid adhesive is approximately horizontal to a force and a measurement direction. The push-pull gauge was fixed, and the envelope paper was coated with the solid adhesive fed from the feeding container by approximately 5 mm at a load of 800 gf to 1000 gf, a speed of 10 cm/second, and an angle of 90°, in a pulling direction of the push-pull gauge, and at this time, a maximum pulling force was designated as the coating resistance. Note that, friction between the base and the envelope paper is negligibly small.

<Evaluation> A value of less than 90 with respect to 100 of the evaluation value of the reference composition was determined as excellent (having a coating resistance reduction effect and light coating feeling).

(b) Coating Amount

An adherend that was fixed was coated with the solid adhesive fed from the feeding container by approximately 5 mm at a load of 800 gf to 1000 gf, a speed of 10 cm/second, and an angle of 90°, in a certain area, and a difference in the weight of the solid adhesive before and after coating was measured and was designated as the coating amount. Envelope paper and an MDF board were used as the adherend.

<Evaluation> A value of 100 or more and less than 200 with respect to 100 of the evaluation value of the reference composition was determined as excellent (an appropriate amount not excessively small or large).

(c) Adhesive Force with Respect to Paper

Envelope paper was coated with the solid adhesive fed from the feeding container by approximately 5 mm at a load of 800 gf to 1000 gf, a speed of 10 cm/second, and an angle of 90°, in an area of 4.5 cm×10 cm, and immediately, envelope paper that was not coated with the solid adhesive was pressure-bonded at a load of 1000 gf such that two sheets of envelope paper were bonded, and a test piece over 8 minutes and a test piece over 10 minutes were respectively prepared.

An average value of values obtained by dividing a paper broken area at the time of peeling off two test pieces at a speed of 10 cm/second by an area coated with the solid adhesive was designated as the adhesive force with respect to paper. The measurement was performed at a temperature of 23° C. and 60% RH.

<Evaluation> A value of 100 or more with respect to 100 of the evaluation value of the reference composition was determined as excellent.

(d) Adhesive Force with Respect to Wood

A paulownia material was evenly coated with the solid adhesive fed from the feeding container, in an area of 9 mm×10 mm, a paulownia material that was not coated with the solid adhesive was pressure-bonded at a load of 1000 gf, and two paulownia materials were bonded and were left in an environment of 23° C. and 60% RH during a whole day and night, and thus, a test piece was prepared.

In the test piece, two paulownia materials of the test piece were pulled at a speed of 5 mm/minutes in directions opposite to each other, in a direction parallel to the adhesive surface, by using a TENSILON universal tester (RTC-1210A, manufactured by ORIENTEC CORPORATION), and a value obtained by dividing a force (a maximum value) required until the adhesive surface was broken by the area coated with the solid adhesive was designated as the adhesive force with respect to wood.

<Evaluation> A value of 95 or more with respect to 100 of the evaluation value of the reference composition was determined as excellent.

(e) Adhesive Force with Respect to Cloth

Cloth (union cloth of polyester-cotton) was evenly coated with the solid adhesive fed from the feeding container, in an area of 25 mm×10 mm, cloth that was not coated with the solid adhesive was pressure-bonded at a load of 1000 gf, and two sheets of cloth were bonded and were left in an environment of 23° C. and 60% RH during a whole day and night, and thus, a test piece was prepared.

In the test piece, two sheets of cloth of the test piece were pulled at a speed of 5 mm/minutes in directions opposite to each other, in a direction parallel to the adhesive surface, by using a TENSILON universal tester, and a value obtained by dividing a force (a maximum value) required until the adhesive surface was broken by the area coated with the solid adhesive was designated as the adhesive force with respect to cloth.

<Evaluation> A value of 100 or more with respect to 100 of the evaluation value of the reference composition was determined as excellent.

(4) pH

Measurement was performed by allowing a piercing pH electrode (pHTestr-10BNC, manufactured by Nikko Hansen & Co., Ltd.) to pierce the solid adhesive at 23° C.

The obtained evaluation results of the solid adhesive are collectively shown in Table 1. From the results of Table 1, it is found that the coating resistance reduction effect is greatly improved while performance such as adhesive properties is retained at the equivalent level or higher, by using the polyvinyl formal resin, compared to a system in which the polyvinyl butyral resin and the polyvinyl pyrrolidone resin are used together (the reference composition, Comparative Examples 2 to 4). In addition, in the case of blending caprolactam instead of the polyvinyl formal resin, the coating resistance is slightly reduced, but the adhesive force with respect to paper becomes weak (Comparative Example 2), and in the case of blending titanium oxide and calcium carbonate, the coating resistance reduction effect is not obtained (Comparative Examples 3 and 4).

### INDUSTRIAL APPLICABILITY

The solid adhesive according to the present disclosure has excellent coating finish and light coating feeling, and thus, is capable of easily adhering not only paper but also wood or cloth. The solid adhesive is capable of adhering wood or cloth while having the same form as that of a water-based solid adhesive of the related art, and thus, is capable of being favorably used in DIY applications, homes, offices, factories, stores, schools, various facilities, and the like.

### ADVANTAGES, FEATURES, AND BENEFITS

The different embodiments and examples of the solid adhesive described herein provide several advantages over known solutions.

Based on the present disclosure, it is possible to provide a solid adhesive that has an excellent finish of a coated surface of an adherend without causing the adherend to be seen as being contaminated and without causing alkali contamination, has light coating feeling, and is also capable of adhering to not only paper but also wood, cloth, or the like. A feed type solid adhesive may also be provided, including a feeding container that is filled with the solid adhesive, e.g., a glue stick.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A solid adhesive, comprising:
water;
an organic solvent;
a gelation agent; and
a polyvinyl formal resin.

2. The solid adhesive according to claim 1, wherein a content of the polyvinyl formal resin is 0.1 mass % to 5.0 mass %, with respect to a total amount of the solid adhesive.

3. The solid adhesive according to claim 2, further comprising:
at least one additional adhesive component selected from the group consisting of a synthetic macromolecule and a natural macromolecule.

4. The solid adhesive according to claim 3, wherein the at least one additional adhesive component is a polyvinyl pyrrolidone resin.

5. The solid adhesive according to claim 2, further comprising:
at least one polyvinyl acetal resin selected from polyvinyl acetal resins other than the polyvinyl formal resin.

6. The solid adhesive according to claim 2, wherein the gelation agent is a dibenzalide of pentavalent to hexavalent sugar alcohol.

7. The solid adhesive according to claim 1, further comprising:
at least one polyvinyl acetal resin selected from polyvinyl acetal resins other than the polyvinyl formal resin.

8. The solid adhesive according to claim 7, wherein the polyvinyl acetal resin is a polyvinyl butyral resin.

9. The solid adhesive according to claim 7, wherein the gelation agent is a dibenzalide of pentavalent to hexavalent sugar alcohol.

10. The solid adhesive according to claim 7, further comprising:
at least one additional adhesive component selected from the group consisting of a synthetic macromolecule and a natural macromolecule.

11. The solid adhesive according to claim 10, wherein the at least one additional adhesive component is a polyvinyl pyrrolidone resin.

12. The solid adhesive according to claim 7, wherein a mass ratio of the polyvinyl formal resin to the polyvinyl acetal resin is 1/99 to 50/50.

13. The solid adhesive according to claim 1, further comprising:
at least one additional adhesive component selected from the group consisting of a synthetic macromolecule and a natural macromolecule.

14. The solid adhesive according to claim 13, wherein the at least one additional adhesive component is a polyvinyl pyrrolidone resin.

15. The solid adhesive according to claim 1, wherein the gelation agent is a dibenzalide of pentavalent to hexavalent sugar alcohol.

16. A feed type solid adhesive, comprising:
a feeding container filled with a solid adhesive;
wherein the solid adhesive includes water, an organic solvent, a gelation agent, and a polyvinyl formal resin.

17. The feed type solid adhesive according to claim 16, wherein a hardness of the solid adhesive is in a range of 1×10⁻⁵ N/cm² to 15×10⁻⁵ N/cm².

18. The feed type solid adhesive according to claim 16, wherein a content of the polyvinyl formal resin is 0.1 mass % to 5.0 mass %, with respect to a total amount of the solid adhesive.

19. The feed type solid adhesive according to claim 16, further comprising at least one polyvinyl acetal resin selected from polyvinyl acetal resins other than the polyvinyl formal resin.

20. The solid adhesive according to claim 19, wherein the polyvinyl acetal resin is a polyvinyl butyral resin.
